(19) United States
(12) Patent Application Publication
(10) Pub. No.: US 2002/0151622 A1
(43) Pub. Date: Oct. 17, 2002

(54) Cellulose fibers and their use in reducing VOC emissions

(76) Inventors: Richard W. Tock, Stafford, TX (US); Daniel W. A'hern, Stafford, TX (US)

Correspondence Address: Alan H. Gordon & Associates, 2925 Briarpark, 9th Floor, Houston, TX, 77042-3728, US

(21) Appl. No.: 09/849,181

(22) Filed: May 5, 2001

Related U.S. Application Data
(63) Continuation-in-part of application No. PCT/US01/04551, filed on Feb. 12, 2001.

(51) Int. Cl. C08J 3/00

(52) U.S. Cl. 524/27

(57) ABSTRACT

Cellulosic materials are used for reducing VOC emission during polymer processing. The cellulosic material is prepared from any of several agricultural by-products including cotton burrs, cotton stalks, corn stalks, flax, hemp, wood flour, and many other plant materials. In one aspect, the present invention involves the use of the cellulosic material to absorb VOCs during the curing of thermoset resins when VOCs are released during the polymerization process. The cellulosic material is added directly to the wet resin surface during cure or to the liquid resin prior to processing. In the latter case, cotton burrs and other cellulosic materials having a lignin content of from about 5 to about 10% allow the cellulosic material to be incorporated into the resin with beneficial results. The cellulosic material is also used in filter elements or adsorption beds to reduce VOC emission during polymerization of both thermoplastic and thermoset resins.

The present application is a continuation-in-part of International Application No. PCT/US01/04551, filed Feb. 12, 2001, and entitled REINFORCED PLASTICS AND THEIR MANUFACTURE.

The present invention relates to the use of cellulose fibers for reducing the emissions of volatile organic carbons (VOCs) during such processes as the manufacturing of reinforced plastics, painting, coating, and other processes in which VOCs are evolved. More particularly, the present invention relates to the use of cellulosic material for reducing VOC emission by modifying composite plastics and by using such fibers for absorption of VOCs.

Reinforced, or composite, plastics are used in a variety of products ranging from automobile parts to spas, tubs, and showers, to septic and underground liquid storage tanks to boats to structural members for the construction industry. Both thermoplastic (polypropylene, polyethylene, polystyrene, ABS, nylon, polycarbonate, thermoplastic polyester, polyphenylene oxide, polysulfone, and PEEK, for example) and thermoset (unsaturated polyester, vinyl ester, epoxy, urethane, and phenolic, for example) plastics are modified with various materials for such uses.

About 60% of all thermoset composites use glass fiber and a thermoset resin. So-called “spray-up” in one-sided molds is a common fabrication process for making fiberglass composite products. Typical fiberglass products made by this method include boat hulls and decks, components for trucks, automobiles, recreational vehicles, spas, tubs, showers, and septic tanks. In a typical open-mold application, the mold is waxed and sprayed with gel coat and, after the gel coat cures, catalyzed thermoset resin (usually polyester or vinyl resin) is sprayed into the mold. A chopper gun chops roving fiberglass directly into the resin spray so that both materials are simultaneously applied to the mold and the spray-up may then be rolled out to compact the laminate. Wood, foam, or other core material may then be added and a secondary spray-up layer is applied to imbed the core between the laminates. The part is then cured, cooled and removed from the reusable mold.

Although not as widely used as thermoset resins, thermoplastic resin use is growing dramatically. Automated injection molding of thermoplastic composites has allowed the use of such composites in many applications previously held by metal casting manufacturers. Typical products include electrical and automotive components, appliance housings, and plastic lumber. Thermoplastic composites are compounded by melt blending the resin with additives and reinforcements and the resin, additive(s), and reinforcement(s) are fed through an extruder where they are combined, exiting the extruder in a strand that is cooled and cut into pellets for subsequent injection molding.

As such plastic composites become accepted in these applications, new markets and applications are opening up and there is increased demand for composites for use in those markets. With this increase in demand, there is a corresponding increase in the production of such plastics. The evolution and subsequent emission of volatile organic compounds is an unfortunate, and well known, consequence of plastic production, and as production increases, increased quantities of VOCs are being emitted. Styrene emissions from unsaturated polyester resins are a common environmental concern. Emissions from spray up fiberglass systems become even more intractable due to the large surface areas generated by the small droplets of uncured resin. It is known to collect exhaust vapors and gases in a spray booth and to send the collected gases and vapors through an oxidation unit, and even though styrene removal efficiencies of 93% have been achieved with this type of oxidation process, styrene emissions remain a major environmental concern for unsaturated polyester polymer processors. There is, therefore, a need for improved suppression of styrene vapor emissions from unsaturated polyester resins and other plastics during the manufacturing and molding processes, as well as from such common manufacturing processes as painting and coating metal.

Although there is widespread recognition of this need to reduce VOC emissions, there does not seem to be a solution. A review of the patent literature, for instance, reveals patents directed to additives for reducing emission of volatile monomers such as rubber graft copolymers (U.S. Pat. No. 5,708,082) and polymer polyester (U.S. Pat. No. 5,948,877), extrusion methods for reducing the amount of residual volatile component to prevent VOC emission (U.S. Pat. Nos. 5,756,658 and 5,760,172), and resins formulated to reduce VOC emissions (U.S. Pat. Nos. 5,688,867 and 5,874,503). U.S. Pat. No. 5,948,877 is particularly instructive on prior attempts to solve this problem, at least with styrene emission when unsaturated polyester resin is utilized, listing several approaches for reducing styrene emission. That patent notes that one approach, replacing styrene with less volatile monomers, is expensive, changes the physical properties of the resulting polystyrene and results in resin systems that are so highly filled that the high viscosities reduce their utility. Another approach is the use of low viscosity oligomers that accommodate lower styrene levels without significantly affecting the physical or application properties of the plystyrene, but as noted in U.S Pat. No. 5,948,877, this approach does not work well in certain applications such as closed mold and highly filled sprayable systems. The third approach listed is the initiation of a film with ultraviolet light, but as noted in U.S Pat. No. 5,948,877, this approach cannot be accomplished in some applications.

In a broad sense, therefore, it is an object of the present invention to provide cellulosic materials, such as from plant byproducts, to reduce VOC emissions from resin systems. As will be described below, the cellulosic materials can be used in more than one way to reduce VOC emissions.

In another aspect, the present invention is directed to methods of manufacturing reinforced thermoplastic and thermoset plastics with decreased emission of VOCs.

In another aspect, the present invention is directed to modified thermoplastic and thermoset plastics that evolve lesser quantities of VOCs during the molding and/or curing processes as a result of the inclusion of a cellulosic material.

In yet another aspect, the present invention is directed to articles such as filter elements incorporating cellulosic materials for use in absorbing VOCs.

More particularly, the present invention provides a composite plastic for absorbing volatile organic carbons comprising a polymer of a thermoset resin and a cellulosic material having a lignin content between about 10 and about 50 weight per cent.

In another aspect, the present invention provides a method of molding plastic articles comprising applying a coating or dusting of cellulosic reinforcing fiber to the molded plastic article before curing the polymeric resin to reduce emissions of volatile organic carbons.

In yet another aspect, the present invention comprises a cellulosic composition for absorbing volatile organic carbons both from liquid resins and from the atmosphere after evolution from a thermoset or thermoplastic resin during cure.

In yet another aspect, the present invention comprises a filter element made from a cellulosic material for removing volatile organic carbons from the gases exhausted from, for instance, a paint or spray booth, oven, or other confined space in which organic compounds including low molecular weight, highly volatile components are released.

In still another aspect, the present invention provides a packaging or shipping container for an article the emits VOCs comprised of a thermoset resin having a cellulosic material incorporated therein for absorbing volatile organic compounds released from the article contained within the shipping container.

Referring now to the figures, FIG. 1 is a schematic diagram of a preferred method of preparing a cellulosic material for use as a modifier for thermoplastic and thermoset plastics.

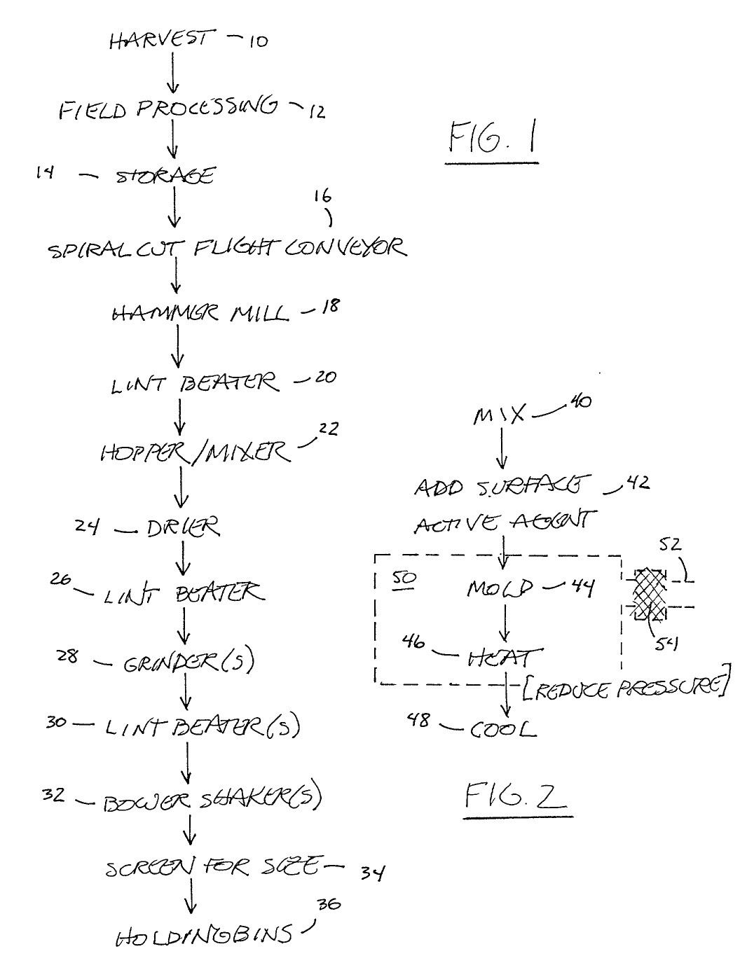

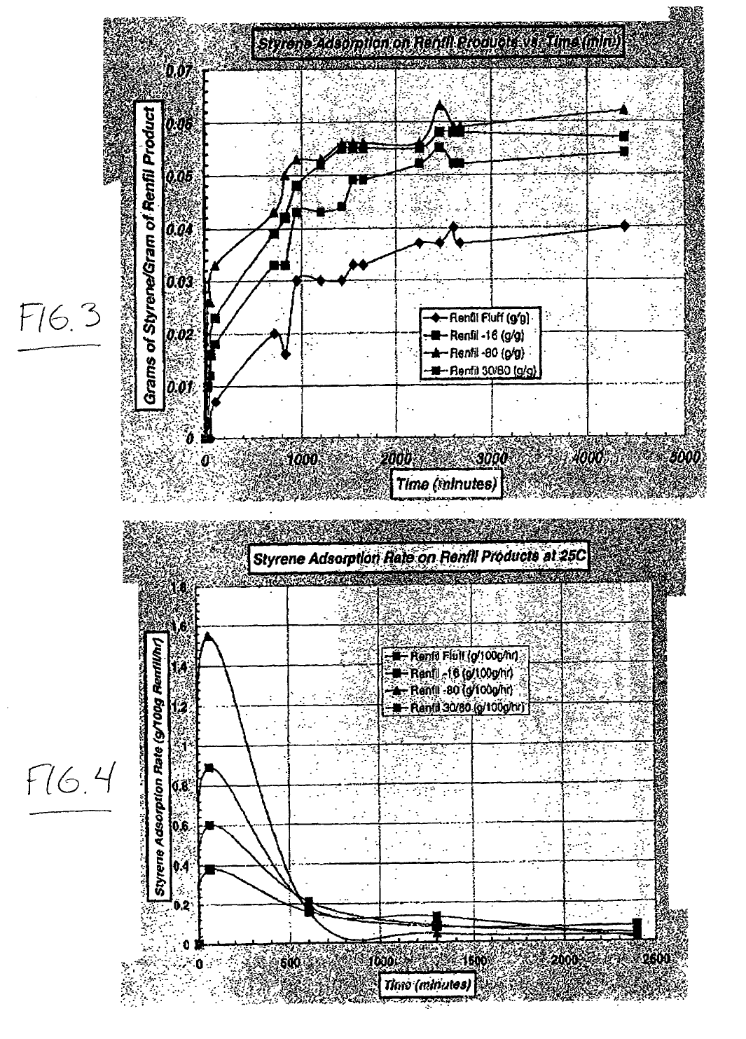

FIG. 2 is a schematic diagram of a preferred method of molding a thermoplastic composite article in accordance with the present invention.

FIG. 3 is a graph showing styrene absorption of a cellulosic material prepared in accordance with the present invention in grams of styrene per gram of cellulosic material as a function of time.

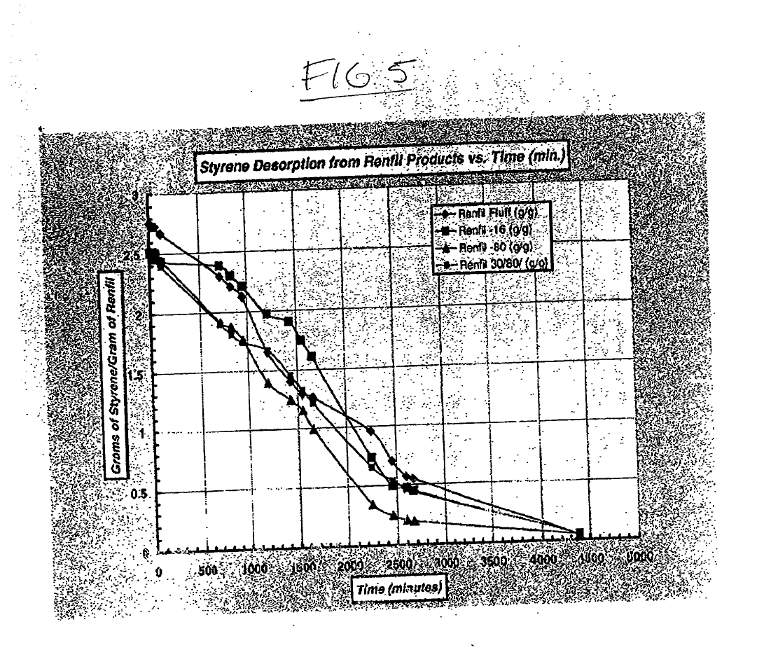

FIG. 4 is a graph showing the rate of styrene absorption of the cellulosic material of FIG. 3 in grams of styrene per 100 grams of cellulosic material per hour.

FIG. 5 is a graph showing styrene desorption of the cellulosic material of FIG. 3 in grams of styrene per gram of cellulosic material as a function of time.

For purposes of illustrating the present invention, a method of preparing a cellulosic material for use in absorbing VOCs from thermoplastic and thermoset resins will first be described. In the particular embodiment described herein, reference is made to the use of cotton burrs as a cellulosic material for absorbing VOCs such plastics, however, as set out below, the invention is not limited in its scope to only the use of cotton burrs as the cellulosic material. The cotton burr is the woody or fibrous portion of the cotton boll that is neither lint nor seed, but does not include the bract, leaves, or stems as more fully described in U.S. Pat. No. 4,670,944, that comprises a portion of what is commonly referred to as cotton gin by-product waste. The use of cotton burrs as a filler or modifier for such plastics is described in U.S. Pat. No. 4,818,604, and both that patent and the aforementioned U.S Pat. No. 4,670,944 are hereby incorporated herein in their entireties by these specific references to those patents. U.S. Pat. No. 4,670,944 describes a method of classifying lignocellulose materials for a variety of uses, including the use of the lignocellulose materials as a filler for plastics as described in U.S. Pat. No. 4,818,604. Briefly, in that method, raw gin trash is cleaned of sand and fine leaf and bract particles in a spiral cut flight conveyor, pulverized in a hammer mill or equivalent, fed through a lint separator in the form of a tube formed of screen with a spike conveyor as the center shaft, the comminuted burrs, stems, and bracts falling through the screen and the lint remaining in the tube.

In the present method, the method described in U.S. Pat. No. 4,670,944 is modified as follows. Referring to FIG. 1, the cotton burr is separated and readily available at a cotton gin where the incoming seed cotton from the field has been harvested or stripped from the stalk by a stripper as described in U.S. Pat. No. 4,670,944 such that most of the leaves, seed, trunk portions, sticks, and stems are not present as at step 10. Often the cotton burrs, as described in U.S. Pat. No. 4,670,944, are stored in the open, for example, in unsheltered windrows. If necessary to prevent water damage, the burrs in the windrows are coated with fumed silica such as is available commercially under the brand names CAB-O-SIL (Cabot Corp.) and AEROSIL (DeGussa) by mixing the fumed silica with a volatile liquid carrier such as methyl alcohol and spraying the mixture on the windrows as at step 12. To decrease the likelihood of fire, a fire retardant such as BORAX may also be mixed with the burrs.

The burrs are preferably (but not required to be) compressed into ricks in the field (step 14) and are then loaded into a spiral cut flight conveyor for cleaning the sand and fine leaf and bract particles from the burrs, the latter as described in U.S. Pat. No. 4,670,944, at step 16. The burrs are then pulverized in a hammer mill or equivalent apparatus as described in that prior patent at step 18 to increase bulk density and conveyed to a series of lint beaters, also of the type described in U.S. Pat. No. 4,670,944, where as much cotton lint as possible is removed at step 20. The burrs are then moved by conveyor, truck and front end loader, or other means as known in the art to a hopper 22 which serves as the intake feed for a dryer 24, preferably a tower drier, for reducing the water content of the burrs to below about 15%, and preferably below 10%. The tower drier also serves as a conveyor for moving the feedstock from the hopper 22 to a second series of lint beaters 26 for removing any remaining lint from the burrs. The burrs fall through the screen of the lint beaters 26 onto a conveyor that feeds the burrs to one or more grinders 28 that grind the feedstock to a very fine material. The ground feedstock is then augured to another series of lint beaters 30 that remove even more lint and then to a series of bower shakers 32 for screening the feedstock to remove more lint and any oversized feedstock (the latter being returned to grinders 28). The remaining feedstock is then conveyed to a series of bower shakers/sifters 34 where the feedstock is screened to selected sizes, each sifter being provided with a conveyor for moving the sized reinforcing fiber to a separate holding bin 36.

Those skilled in the art who have the benefit of this disclosure will recognize that a number of modifications of this process are possible and, in some instances, even desirable. For instance, if the amount of moisture in the stored burrs 14 is low enough that forced air drying such as in the tower drier 24 is not required, the stored burrs 14 may be dessicated, and remain dessicated, by spreading a bed of dessicant on supporting structure and then covering the dessicant with a mesh and placing the burrs over the mesh. Calcium chloride, about two inches thick, is an acceptable bed. A 16 mesh or smaller wire screen is a satisfactory boundary. It is also noted that moisture does not penetrate very far into ricks of the stored cotton burrs such that it generally is not necessary to treat the stored burrs with fumed silica if the burrs are compressed into ricks.

Another example of a modification to the above-described process is when the process is modified for use with cellulosic materials other than cotton burrs. An example of such a material is the stalk, stems, and leaves of the cotton plant. As set out in the aforementioned U.S. Pat. No. 4,670,944, in certain parts of the United States, cotton is customarily harvested by stripping the cotton bolls from the plant. Stripping usually involves stripping the leaves, sticks, and limbs, as well as the bolls, and leaves the stalk standing in the field. The normal practice is to shred or chop the remaining stalks and then spread them on the field and plow them under. In other parts of the U.S., and in many cotton growing areas in other countries where the cotton plant is much taller, the cotton is picked from the boll, leaving the stalk, stems, leaves, and burr standing in the field. The plant is then shredded or chopped, after which it is plowed under or otherwise disposed of. If used as a cellulosic material in accordance with the present invention, however, the stalks are harvested and either transported directly to a location at which the above-described process is conducted or stored in ricks until used as a feedstock for the above-described process.

As described in International Application No. PCT/US01/04551, the entirety of which is hereby incorporated herein by this specific reference, the use of such materials as cotton stalks as a feedstock for making a reinforcing fiber for reinforced thermoplastic and thermoset plastics is based upon the discovery that the combination of the lignin and the inorganic ash content of the cotton burrs makes them particularly well-suited for use as a reinforcing fiber for such plastics, and the further discovery that cotton stalks and other cellulosic materials can be modified by addition of lignin and inorganic silica to function as acceptable substitutes for cotton burrs in such fillers. The lignin, which is a by-product of making paper pulp from trees and is available commercially under such brand names as LIGNOCITE (Georgia Pacific), is absorbed onto the cellulose fiber so that the fiber more readily bonds with such polymers as polyesters, polystyrene, polyethylene, polyvinyl chloride, polypropylene, and other polymers. The lignin also helps bond the cellulosic material to fiberglass and other polymeric constructs.

The lignin is preferably absorbed onto the cellulosic material at step 22 of the above-described method by mixing the cellulosic material with liquid lignin in a mill or other suitable apparatus that serves as the inlet feed to the drier 24. It is preferred that enough lignin be added to the cellulosic material to bring the final lignin content of the reinforcing fiber to approximately 20-50 weight percent of the reinforcing fiber, and preferably 30-45 weight percent. Those skilled in the art will recognize from this disclosure that the amount of lignin that is added to the cellulosic material will vary depending upon the lignin content of the raw cellulosic material. Acceptable performance of the reinforcing fiber can also be obtained, depending upon the end use of the reinforcing fiber, by absorbing one or more of the primary precursors of lignin, trans-coniferyl, trans-sinapyl, and/or trans-p-coumaryl alcohol, onto the cellulosic material. Any one or more of these precursors may also be used, in generally smaller proportions, in addition to commercially available lignin, to optimize desirable physical parameters of the final product molded with the cellulosic reinforcing fiber of the present invention. However, it is not necessary to add lignin to the cellulosic material for the cellulosic material to function as an adsorbent of VOCs during the curing of the plastic in accordance with the present invention. In other words, cellulosic materials that have been comminuted and treated in the manner described above will function for the intended purpose of absorbing VOCs. An added benefit of using cellulosic materials to absorb VOCs is that if the cellulosic material has a high lignin content, or can be treated to increase the lignin content, the cellulosic material can be used as a filler, or reinforcing fiber, in a thermoset plastic without adversely affecting the physical properties of the resulting molded composite plastic. To the contrary, such cellulosic materials have actually been shown (as described in International Application No. PCT/US01/04521) to have a beneficial effect on the physical properties of the composite plastic. By modifying the cellulosic material in this manner, such materials as cotton stalks, flax, hemp, jute, cotton seed, rice hulls, wheat straw, corn stalks, peanut shells, sunflower shells, sunflower stalks, sugar cane, wood flour, wood pulp, sawdust, wood chips, tree bark, and many other agricultural by-products, as well as mixtures of these materials, are utilized as the raw material for making the cellulosic material of the present invention. In contemplation of the use of such materials as the raw material for making a reinforcing fiber according to the present invention, reference is made herein to the use of scrap material produced as a by-product of the processing of an agricultural product

When used as a component of a thermoset resin system, the cellulosic material is used as either the main body of the construct or to modify the structure and/or physical behavior of the resulting construct. The addition of as little as 2 percent of the reinforcing fiber (weight or volume) into some thermosetting resins will result in sufficient modification of the physical behavior of the resulting construct to adapt the construct for use in certain applications. Likewise, the inclusion of as much as 98 percent reinforcing fiber (weight or volume) with a 2 percent inclusion of resin, used as a physical binder, is sufficient for some constructs. All known unsaturated thermosetting polyesters, including alkyd, allyls, and other such polymers as those made in a condensation reaction between difunctional acids and glycols, dissolved in unsaturated monomers, tailored according to the particular application, have shown affinity for the reinforcing fiber. Likewise, vinyl esters and polyester/urethane hybrids, those combining phenols and aldehydes, either “two stage” novolacs, or “single stage” resols of phenolics show positive reaction to the lignin groups contained in the reinforcing fiber. The amino resins of melamine and urea likewise display structural behavior, tailored to the cellulosic content of the fiber. The reinforcing fiber is utilized as both a blowing agent for polyurethanes and for improving the strength of the resulting molded composite article.

The epoxy groups, characterized by a three-membered ring structure, with the addition of compounds containing active hydrogen atoms such as amines, acids, phenols, and alcohols, that react by opening the ring to form a hydroxyl group also react with the lignin groups within the fiber. A modification that is peculiar to the behavior of these epoxy families occurs with the addition of the fiber, stabilizing the exothermic reaction, to inhibit “critical mass” behavior normally exhibited beyond fifty gram weight mass.

These thermoset resins may be utilized in many know manufacturing methods, including all forms of lay-up, spray-up laminated coatings, bulk castings, bulk molding compounds (BMC), sheet molding compounds (SMC), and other such method of molding and manufacturing as known to those skilled in the art. Depending upon the particular thermoset resin, catalyst (as well as the additive package), and the desired properties of the composite molded article, resins including the reinforcing fiber of the present invention are molded at temperatures ranging from ambient and up and at pressures above and below ambient, all as known in the art. The cellulosic material is mixed with the liquid resin preferably at levels ranging from about 1 to about 15% by weight. Although there are applications for highly viscous resins, as a general rule, the more cellulosic material that is added to the liquid resin, the higher the viscosity, and the increase in viscosity has the effect of limiting the proportion of cellulosic material. If so, VOC emission is reduced even further by dusting or spraying the surface of the wet resin with the cellulosic material while it is in the process of curing.

As noted above, the ratio of cellulosic fiber to thermoset polymer is varied in accordance with the desired properties of the resulting product and the amount of VOC that is to be absorbed, it being contemplated that, in the case of the polystyrene polymer described herein, a ratio of about one part reinforcing fiber to about one part polymer is as high as is likely to be useful in most applications because, if a higher ratio is utilized, the resulting molded article is more rigid and brittle. There are, however, applications in which a rigid and/or brittle molded article is desirable. For that reason, the method of the present invention contemplates the reduction of VOC emission from thermoset polymers by adding cellulosic material to the liquid resin in a ratio of cellulosic fiber to polymer that may be as high as about one part reinforcing fiber to about 0.25 parts polymer. By contrast, a lower ratio of reinforcing fiber to polymer, for instance, about one part reinforcing fiber to about three parts polymer, generally results in a molded article that is more pliable. Again, there are applications in which that pliability is desirable such that the method of the present invention contemplates that the reinforcing fiber and polymer may be blended in a ratio as low as about one part reinforcing fiber to about thirty parts polymer. Of course the ratios set out herein also depend on the particular polymer that is being blended with the reinforcing fiber. For instance, in the case of certain polymers, the resulting molded article may be brittle even when reinforcing fiber and polymer are utilized in a ratio of, for instance, about 1:5 such that the present invention contemplates that those skilled in the art will find it beneficial to alter the ratio of reinforcing fiber to polymer experimentally to arrive at an optimum ratio for a particular application.

Experimentation has shown that more finely ground cellulosic material (<80 mesh), which have greater exposed surface areas, are better incorporated into the liquid thermoset resins, either during resin molding operations or at some other convenient time during the curing process. As described in more detail in International Application No. PCT/US01/04551, the cellulosic material is actually incorporated into the polymer matrix of such resins upon curing and it appears that the cellulosic material that is incorporated into the matrix retains its ability to adsorb the volatile contituents of the thermoset resin, thereby reducing the volume of potential VOCs. When the cellulosic material is applied to the wet thermoset resin, it appears that there may be some incorporation of the cellulosic material into the polymer matrix at the boundary between the resin and the cellulosic material that helps adhere the cellulosic material to the outer surface of the resin but that the cellulosic material functions as an adsorptive barrier to the escape of the volatile constituents from the resin. It also appears that something akin to a skin coat forms at the interface of the wet resin and the cellulosic material that acts in a manner similar to a physical barrier to retard the loss of volatiles.

By reference to FIG. 2, the use of the cellulosic material of the present invention for absorbing VOCs emitted from thermoplastic polymers such polystyrene is illustrated. A commercially available bead form styrene is mixed with a cellulosic reinforcing fiber as a step 40 in a ratio of approximately two parts polystyrene beads to one part reinforcing fiber in a ribbon blender or similar agitating mixing device all as described in the above-incorporated International Application No. PCT/US01/04551 for the purpose of improving the physical characteristics of the resulting composite molded article. A quantity of surface active agent comprising approximately 1% by weight of the total polystyrene bead content is added to this mixture at step 42 to promote uniform dispersion of the two components and to promote adhesive bonding between the reinforcing fiber and the polymer when molding. The polymer, reinforcing fiber, and surface agent mixture is then introduced into a mold as at step 44 shaped to the size of the desired molded product and the mold heated at step 46 to a temperature in excess of the glass transition temperature of the polymer for sufficient time to expand the polymer to the shape of the mold. The mold is then cooled as at step 48 to cure the expanded polystyrene.

Although not necessary, it is preferred that a reduction from atmospheric pressure be utilized during the heating step 46 to cause the polymer beads to swell or “blow” more quickly and at a lower temperature. It is desirable to avoid high temperatures to avoid degenerating the strength of the composite article. If a reduction is pressure is utilized in the method of the present invention, a reduction from atmospheric pressure of about 5 inches of mercury is generally adequate to provide these desirable benefits. Those skilled in the art who have the benefit of this disclosure will recognize that greater reductions in pressure may result in more such beneficial results but at the cost of increased cost of production. Regardless of the pressure or temperature, the system evolves VOCs, and in a preferred embodiment, the evolution of VOCs occurs in an enclosed space 50 from which the gases are exhausted into a duct 52 and through a filter or packed bed 54 comprised of the cellulosic material of the present invention and as described in more detail below.

Those skilled in the art will also recognize that, although reference is made herein to polystyrene, the method of the present invention is also practiced with equally satisfactory results using many other thermoplastic melt processable polymers such as polypropylene, polyethylene, polyvinyl chloride, copolymers, tertiary polymers, including interpenetrating polymer networks, and their admixtures all as described in International Application No. PCT/US01/04551. Thermoplastic processing via injection, compression, extrusion, pulltrusion, melt coating, rotorotational molding, and other such methods are contemplated by the use of the term “molded” herein. It will also be recognized that thermosetting polymers may be substituted, in part or in whole, into the substituted polymer matrix or as an included modifier to a selected percentage ratio to the primary polymer to adjust the desired physical properties of the resulting molded product, the method of manufacturing that molded product, of the value benefit of the final product. In short, those skilled in the art will recognize from this disclosure that, even though certain thermoplastic polymers and methods of manufacture are described herein, the polymers and methods described herein are exemplary and that the cellulosic material is effective in absorbing VOCs from a wide range of possible combinations of polymers, combinations of polymers, modifiers and stabilizing additives, and during a wide range of methods of manufacturing molded articles with these systems.

Although not required, it is generally preferred that cellulose material having a relatively large particle size be utilized in packed beds for adsorbing VOCs from thermoplastic systems. Although smaller sizes are effective in adsorbing VOCs in such systems, experimentation has shown that larger particulates (>80 mesh) are even more effective when utilized in a packed adsorption bed such as is shown in FIG. 2.

Laboratory and field observations indicate that such cellulosic materials have a strong affinity for styrene monomer and other VOCs. This affinity is particularly evident when utilized in a glass fiber/polyester resin spray-up application. To illustrate this affinity, when a cellulosic material prepared in accordance with the above-described method was used as a reinforcing fiber with a commercially available polyester resin containing about 42% by weight styrene and a dusting of the same reinforcing fiber was applied to the wet, uncured surface of the composite structure, the smell of styrene vapor in the immediate work area was noticeably reduced. In addition, it was observed that the mixing of the cellulose material with the uncured polyester resin (PER) prior to spray-up dramatically prolonged the onset of the mixture's gel time when the recommended activator was used. Both these observations have been confirmed under laboratory conditions as described below, indicating that cellulosic material prepared in accordance with the present invention functions as an adsorbent for the styrene monomer contained in the uncured polyester resin.

In tests using liquid solutions of styrene polyester resin and a liquid, inhibited styrene monomer as sources of styrene vapor and liquid, four cellulosic materials were used. All four were prepared from cotton burrs by the method described above and sorted according to particle size, the different grades being designated by the mesh size through which they pass, e.g., −16, a mix of −30 and −80 (30/80), −80, and fluff. All experiments were conducted in a vented hood and at ambient temperatures except for those instances where exotherms were generated during curing of the PER.

In a first experiment, the liquid PER was poured into a laboratory beaker. The concentration of styrene vapors in the headspace directly above the top of the liquid solution was then measured with sniff probes manufactured by Drager. These detector tubes can be utilized only once, are specific to styrene vapor, and are usually used to screen gas spaces. The results are set out in the following Table 1:

TABLE 1
Styrene Sniff Tests with Drager Tubes

| | | Styrene |
|---|---|---|
| Test | | Detected |
| No. | Test Description | (%) |
| 1 | ˜100 grams of PER (42% styrene by weight) placed | ˜35 ppm |
| | in a 500 ml beaker | |
| 2 | ˜5 grams 30/80 (4.8% by weight) were dusted on | ˜10 ppm |
| | top of the resin in #1 | (˜70%) |
| 3 | ˜15.4 additional grams 30/80 added to the beaker in | ˜9 ppm |
| | #2 to give ˜17% by weight; the mixture was stirred | (˜75%) |
| | for 15 minutes and retested with sniff tube | |
| 4 | Sample #3 was again tested after 15 minutes | ˜10 ppm |
| | | (˜70%) |
| 5 | After an additional 15 minutes, another sniff test was | ˜10 ppm |
| | performed on sample #3 | (˜70%) |
| 6 | After setting for ˜11 hours, sample #3 was sniff tested | ˜8 ppm |
| | again | (˜80%) |
| 7 | A fresh 25 grams of resin were placed in a second | ˜40 ppm |
| | beaker and sniffed twice | |

The data in Table 1 suggests that the 30/80 cellulose material suppresses over 70% of the styrene vapor emitted from the base resin. This level of reduction remained effective even when the cellulosic material is blended with the liquid resin and the suspension was allowed to stand.

A second series of experiments quantified the interaction of styrene with the cellulosic material using production grade, inhibited liquid styrene monomer. Known masses of the cellulosic materials were placed in metal wire baskets and suspended over 200 ml of liquid styrene contained in a 2.0 beaker and placed in a vented hood. The draft of air through the hood was sufficient to draw styrene vapors from the liquid surface, past the suspended cellulosic material, and on out the vent. The sample baskets containing the cellulosic material were removed periodically from the hood and beaker, quickly weighed to the nearest 0.01 g, repositioned in the beaker above the liquid styrene, and returned to the hood. Over time, the absorbed styrene was thereby recorded as a weight gain in grams of styrene per gram of cellulosic material as a function of time. Total elapsed time was just over three days. The results are shown in FIG. 3. The amount of styrene absorbed for each size of cellulosic material rises from zero to a level of about 0.06 grams/gram. The vapor pressure of pure liquid styrene is about 9 mm Hg at 25° C. (˜76° F.), which is a relatively low driving force for absorption.

The curves for the adsorption measurements shown in FIG. 3 demonstrated some erratic behavior, ostensibly from experimental variation and/or error. However, the data as plotted suggest that the finer ground cellulosic material (−80) absorbs a gereater mass of styrene vapors and at a faster rate than the other three materials. Also, except for the fluff material, nearly half of the total styrene absorbed accumulates on the cellulosic material during the first twenty minutes. The data shown in FIG. 1 were lumped into five average time groups (four groups if the zero point time is excluded) and the average amount of styrene absorbed was then calculated. These reduced data are given as the average amount/rate of styrene absorbed (g styrene/100 g cellulosic material/hr) in Table 2 and shown in FIG. 4:

TABLE 2
Adsorption Rate for Styrene

| Average Time (mins.) | Fluff | −16 | −80 | 30/80 |
|---|---|---|---|---|
| 0 | 0 | 0 | 0 | 0 |
| 60 | 0.380 | 0.600 | 1.55 | 0.891 |
| 600 | 0.157 | 0.210 | 0.154 | 0.186 |
| 1300 | 0.078 | 0.042 | 0.029 | 0.018 |

Table 2 and FIG. 4 suggest that the finer the particles of cellulosic material, the more rapid adsorption of the styrene vapor. The suggestion by the data that the maximum adsorption rate occurs at approximately one hour may be an artifact of data averaging. The most rapid rate of uptake occurs following the instantaneous contact between the cellulosic material and the styrene vapors, after which the sites available on the cellulosic material for adsorption diminish. Even so, the averaged rate of 1.55 g/100 g/hr for the −80 cellulosic material is almost double that of the mixed 30/80 and the −16 materials.

In similar fashion, desorption studies were conducted by first saturating known masses of the cellulosic material with the inhibited liquid styrene in a 250 ml beaker. Beakers containing the cellulosic material were then placed inside a vacuum oven, heated to 80° C. (˜175° F.), and left under the vaccum of ˜27 inches of Hg for five hours. This preconditioning step was intended to remove any residual adsorbed moisture or volatiles from the cellulosic material; it was also discovered that when preconditioned in this manner, the cellulosic material adsorbed much more of the liquid styrene. The beakers containing the samples of cellulosic material were then removed from the vacuum oven, cooled to ambient temperature, and reweighed. In so far as was possible, 2.5 grams of styrene per gram of dried cellulosic material were then added to each sample beaker. The mass ratio of 2.5/1.0 is approximately the oil adsorption number for the cellulosic material. Hence very little, if any, free standing liquid styrene could be seen on the top surface of the cellulosic material in each beaker. The beakers were positioned in the vent hood so that the forced airflow passed over the tops of the beakers and provided a continuous driving force for evaporation from the cellulosic material's exposed surfaces. This desorption process was measured as a mass loss in grams styrene per gram of preconditioned cellulosic material as a function of elapsed time and the results over a period of about three days at ambient temperature are shown in FIG. 5.

The data at three days in FIG. 5 is roughly equivalent to the data obtained at maximum adsorption. The data for the initial portion of the desorption curves indicate some instabilities typical of styrene systems not at equilibrium, particularly for the larger cellulosic material particles (−16) with its delayed release of styrene vapor. However, after the first ten hours, desorption rates for all four sizes of cellulosic material is roughly parallel. Therefore, if all the data between 500 minutes and 2500 minutes are lumped together and fit to a linear line, the desorption rate for all products is about 5.4 grams/100 grams of cellulosic material/hour. This value is approximately equal to the adsorption rate considering that adsorption rate as calculated above was determined by an averaging reduction of the data. The desorption data indicates that the finer particle size (−80) of cellulosic material, with its increased surface area, results in a greater desorption rate of the adsorbed styrene.

For maximum reduction of VOCs, the reinforcing fiber is mixed with the PER liquid resin. For instance, if the reinforcing fiber is added in an amount comprising about 10% by weight to a general purpose PER such as STYOL 20-4221 or 40-4232 (Cook Composites and Polymers Company, Kansas City, Mo.) and catalyzed with 0.9 to 2.0% methyl-ethyl ketone peroxide (MEKP), the resulting mixture contains about 50-60% solids and the balance is liquid styrene, and when this mixture is molded in the manner described above, free styrene vapor emissions are reduced by the absorption of about 2.2 to 2.8 times the weight of the liquid styrene component in the resin, with a reduction of vapor emissions by as much as 50%. Further testing has shown that the addition of about 10% by volume of the reinforcing fiber of the present invention to polyester resins results in a weight loss reduction of styrene of approximately 43%.

It appears that the reduction in styrene vapors (VOCs) from polyester resins is a transient phenomenon and that at least three factors are involved in this method of reducing VOC emissions from PER production. First, the reinforcing fiber appears to physically absorb styrene from the PER solution and effectively reduce initial vaporization. This absorption is selective to styrene because of the relatively low molecular weight of styrene compared to the molecular weight of the polyester component of the resin solution. Second, the styrene absorbed into the reinforcing fiber, however, is still driven off by elevated temperature such that, at or about the peak temperature, the vapor pressure of the styrene and, hence, the styrene emissions, will also peak and then subside. This effect is most noticeable for large molded composite articles in which the heat of the polymerization process builds rapidly in the mold due to a decrease in the thermal conductivity of the cured resin. Third, the free styrene in the PER solution also reacts to become a portion of the polymer structure during cure. This reaction effectively removes and/or prevents the styrene monomer from becoming a part of the VOC that is generated.

In light of these three factors, styrene vapor emission is best reduced by mixing the reinforcing fiber with the PER to temporarily “lock up” the styrene monomer by absorption into the reinforcing fiber as described above. Second, rapid curing processes that avoid excursions into high temperatures provides the best opportunity for locking the styrene monomer into high molecular weight polymers and eliminating the migration and loss of the monomer to the vapor phase. Because rapid PER cure rates also produce high peak cure temperatures, the present invention contemplates optimization of the cure rate, followed by the cooling of the molds, in a manner known to those skilled in the art to reduce VOC emissions.

In another aspect of the present invention, a further reduction in VOC emission is achieved by spraying or otherwise applying a cover coating of the reinforcing fiber described above to the molded composite article. The preferred method of application of the cover coat is by the use of a so-called “particle pump” such as that manufactured by Venus-1 Magnum Corporation (St. Petersburg, Fla.). The reinforcing fiber is loaded into a storage hopper that is coupled to a compressed air stream venturi outlet and the reinforcing fiber is mixed into the compressed air stream and propelled through an application nozzle to be deposited onto the surface of the still wet molded composite article. The dry stream of reinforcing fiber appears to bond to the wet surface via capillary attraction, providing further absorption of styrene monomer and functioning in a manner similar to a physical barrier to prevent escape of VOCs by evaporation of these objectionable emissions.

If this airflow cover coating of the reinforcing fiber of the present invention is the final surface of the molded composite article, this coating is left intact as a barrier to further emissions during the final exothermic cure of the article in the manner described above. However, should it be desired to apply further laminations, either to build bulk volume (and thus increase the overall physical performance of the article) or to attach structural elements to the molded composite article (e.g., to attach the pedestal to a molded sink basin), the process is then repeated, several times if necessary, overcoating the dry sprayed layer of reinforcing fiber with a new wet coating of resin. Care must be taken that a sufficient volume of resin is applied to the dry coat of reinforcing fiber to avoid formation of voids in the interior of the laminate.

The saturated layer of reinforcing fiber appears to function in a manner similar to the core of a laminate, providing both bulk volume without requiring the use of more expensive resins and reinforcing materials and performing a coupling and performance role that increases the physical performance characteristics of the final article. With regard to the latter, these laminated structural cores appear to function according to the teachings of the so-called Milewski packing theory (H.S. Katz and J. V. Milewski, Handbook of Fillers for Plastics, New York: Chapman and Hall (1987)) to enhance the ultimate physical performance of the final molded composite article. In accordance with this theory, the use of a combination of reinforcing shapes and sizes of particles as provided by the cellulosic reinforcing fiber of the present invention completes the matrix structure of the polymer, reinforcing and allowing stress transfer behavior throughout the entire structure, reinforcing the what would have otherwise been unprotected resin deposits, and filling the spaces between the reinforcing fibers. The combination of the cellulosic reinforcing fiber of the present invention and the resulting reinforcement provides a more ductile molded composite that is more forgiving of the more normal “micro-cracking” failure modes. By enhancing the behavior of these reinforcing materials in this manner, the present invention makes possible the substitution of what would have otherwise been the non-performing portion of the fibrous glass materials with the less expensive cellulosic reinforcing fiber without a direct percentage loss in physical properties, yet increasing other desirable properties of behavior such as impact resistance.

The expected physical properties of these composite molded articles can be tested and expressed alone, for instance, as tensile strength, flexural strength, compressive strength, and impact stength, or in a resulting combination that is necessary to produce a specific designed combination of properties or behavior when exposed to certain stresses. Testing by accelerating the speed of the stress that is applied to the composite, molded article in a uniaxial direction combines all these forces and stengths, noting a ductile vs. brittle failure model. Long term flexural fatigue can, for instance, be reasonably predicted with this model while the rate of failure by instant impact loadings can be shown in a “better or worse” behavior model, thus establishing a composite design guidance reflecting these combinations of forces to the entire model. Adjusting the performance behavior of the molded, composite article can be accomplished with a high degree of confidence by following this model and by doing so, testing indicates that properly applied and void free, lamination of the molded, composite article in this manner can result in a doubling of the ultimate impact strength of the finished article.

Another benefit of the use of the cellulosic reinforcing fiber in this manner has been discovered when a “suppressed” resin is used to reduce VOC emission and additional layers or laminations are to be applied to the molded article. When such resins are used, an expensive and tedious process of removing the suppressing wax layer is necessary to achieve further bonding of the laminations. However, the application of the reinforcing fiber of the present invention to the wet coating of suppressed resin and further application of wet coatings results in a laminate having superior physical properties without the need for the tedious and expensive process of removing the wax layer.

Testing has shown that with the addition of about 10% reinforcing fiber to the resin and application of the reinforcing fiber as an overcoat, a reduction in emissions of up to about 80% can be achieved, both as an apparent result of the absorption capacity of the reinforcing fiber and its function as a mechanical barrier to emissions. It is preferred that the reinforcing fiber overcoat be applied to the molded article no later than about ten minutes prior to the onset of the exothermic reaction since testing has shown that about 70% of the evolved weight loss occurs within the first increase in the exotherm and before the resin reaches 50% of peak temperature.

A unique aspect of the present invention is the use of the cellulosic material of the present invention for filtering or removing VOCs from, for instance, the vented exhaust gasses of a spray booth. Loose cellulosic material is simply poured onto a screen having a mesh size smaller than the particle size of the cellulosic material that is positioned in the outlet duct from the spray booth or packed into a bed or filter box in a manner similar to that described above for use with thermoplastic polymers. When the bed of cellulosic material becomes saturated with styrene, the saturated cellulosic material is replaced and then simply added to the spray-up process. The saturated cellulosic material simply adds to the composite structure as it cures.

In an alternative aspect, the cellulosic material is molded into a composite article using a very high ratio of cellulosic material to resin (in the range of 4:1) so that only enough resin is used to enable the resulting molded article to retain its shape. In one preferred embodiment, this article takes the form of a sheet that is mounted into a frame for use as a filter element in a spray or paint booth or in the exhaust duct of a coating or spray-up booth. The sheet may be pleated to increase the surface area, and hence the cellulosic material available for absorbing VOCs emitted during the process. The saturated filter element need not be thrown away; instead, it is simply passed through a hammer mill and the resulting particles are added to the spray-up process in the same manner as described above.

As described above, the cellulosic reinforcing fiber of the present invention is also used to improve the strength and other physical properties of composite molded articles. As a result of this capability of the cellulose material, in another aspect, the cellulose material of the present invention is used to make shipping containers for newly painted and/or coated articles that are capable of absorbing VOCs evolved from the paint or coating as the paint or coating hardens, or cures. The strength of such composite molded articles allows their use as shipping crates or containers. If the article being shipped is likely to emit more than enough VOCs to saturate the cellulosic material incorporated into the composite plastic comprising such a container, a layer of the cellulosic material is simply applied to the inside surface of the composite plastic to provide additional adsorption capability.

Although the inventions described herein are described in conjunction with the preferred embodiments that are illustrated in the figures, certain variations in those embodiments which are equivalents are intended to fall within the scope of the following claims.

What is claimed is:

1. A composite plastic for absorbing volatile organic compounds comprising a thermoset resin and a cellulosic material, said cellulosic material comprising lignin in about 10 to about 50 weight percent, produced by mixing the cellulosic material with the liquid resin before curing.

2. The composite plastic of claim 1 wherein said cellulosic material comprises less than about 15% water.

3. The composite plastic of claim 1 wherein the particle size of said cellulosic material is less than about 80 mesh.

4. The composite plastic of claim 1 comprising about one part of said cellulosic material to about 0.25 to about 30 parts of said polymeric resin.

5. The composite plastic of claim 1 additionally comprising a coating of said cellulosic material applied to the wet surface of said resin.

6. A molded article comprised of the composite plastic of claim 1.

7. In a method of molding plastic articles using a thermoset resin, the improvement comprising adding a cellulosic material to the resin before curing to reduce emissions of volatile organic compounds.

8. The improved method of claim 9 wherein said cellulosic material additionally comprises between about 10 and about 50 weight percent of lignin.

9. The improved method of claim 7 additionally comprising applying a coating of the cellulosic material over the wet mixture of cellulosic material and resin.

10. The improved method of claim 7 wherein the resin is a styrene resin and the coating of cellulosic material is applied no later than about ten minutes prior to the onset of the exothermic reaction.

11. The improved method of claim 10 wherein the cellulosic material is applied prior to the onset of polymerization of the resin.

12. The improved method of claim 7 additionally comprising accelerating the curing of the resin.

13. The improved method of claim 12 additionally comprising limiting the temperature at which the resin cures.

14. The improved method of claim 7 additionally comprising limiting the temperature at which the resin cures.

15. A molded plastic article made by the process of claim 7.

16. The improved method of claim 8 wherein said cellulosic material is selected from the group consisting of cotton burrs, cotton stalks, flax, hemp, jute, cotton seed, rice hulls, wheat straw, corn stalks, peanut shells, sunflower shells, sunflower stalks, sugar cane, wood flour, wood pulp, sawdust, wood chips, tree bark, and mixtures thereof.

17. The improved method of claim 7 wherein said cellulosic material comprises approximately equal parts of particles passing through a 30 mesh screen and particles passing through an 80 mesh screen.

18. The improved method of claim 7 wherein said cellulosic material comprises particles in sizes up to approximately 80 mesh.

19. The improved method of claim 7 additionally comprising absorbing lignin onto the cellulosic material.

20. The improved method of claim 7 additionally comprising absorbing onto the cellulosic material one or more primary precursors of lignin, trans-coniferyl, trans-synaptyl, and trans-p-coumaryl alcohol.

21. In a method of adsorbing volatile organic compounds produced during curing of resin systems, the improvement comprising adsorbing volatile organic compounds by contacting the process air stream with a cellulosic material.

22. The method of claim 21 wherein the cellulosic material is preconditioned before adding to the polymeric resin by saturating the cellulosic material with the resin and then desorbing the resin from the saturated cellulosic material.
